(19) United States
(12) Patent Application Publication
(10) Pub. No.: US 2013/0079161 A1
(43) Pub. Date: Mar. 28, 2013

(54) ELASTIC HOLD-TYPE ROTARY SHAFT STRUCTURE

(71) Applicants: AN SZU HSU, NEW TAIPEI CITY (TW); CHIEN CHENG MAI, NEW TAIPEI CITY (TW); CHIEN-NAN TSAI, NEW TAIPEI CITY (TW)

(72) Inventors: AN SZU HSU, NEW TAIPEI CITY (TW); CHIEN CHENG MAI, NEW TAIPEI CITY (TW); CHIEN-NAN TSAI, NEW TAIPEI CITY (TW)

(73) Assignee: FIRST DOME CORPORATION, NEW TAIPEI CITY (TW)

(21) Appl. No.: 13/241,916

(22) Filed: Sep. 23, 2011

(51) Int. Cl. F16D 3/00

(52) U.S. Cl. 464/51

(57) ABSTRACT

An elastic hold-type rotary shaft structure includes a first holding member and a second holding member and an elastic member. One side of the first holding member is formed with a pivot section and one side of the second holding member is formed with another pivot section. The pivot sections are pivotally connected with each other. The middle sections of the first and second holding members are formed with corresponding holding sections for receiving and holding a rotary shaft. The elastic member is connected between the other sides of the first and second holding members distal from the pivot sections. The elastic member applies elastic force to the first and second holding members to keep the first and second holding members elastically holding the rotary shaft and applying a frictional force to the rotary shaft when rotated. Accordingly, the rotary shaft can be located in any desired angular position.

### BACKGROUND OF THE INVENTION

1. Field of the Invention

The present invention relates generally to an improved elastic hold-type rotary shaft structure, and more particularly to a rotary shaft structure, which has simpler structure and is easily adjustable in elasticity to provide greater holding force. Moreover, the elastic hold-type rotary shaft structure is easy to assemble.

2. Description of the Related Art

Various electronic products with snap-on covers or snap-on screens have been developed in the market. Such snap-on covers employ various newly developed pivot devices. FIGS. 1 and 2 show a conventional pivot device including a pivot seat 5, a pivot pin 50, a first cam 6, a second cam 6a identical to the first cam 6, two identical retainer plates 7, 7a and an elastic member 70. The pivot seat 5 has a sideboard 51 perpendicularly extending from the pivot seat 5. The sideboard 51 is formed with a central pinhole 52. A raised stop section 55 is disposed beside the pinhole 52. A flange section 501 is disposed at the middle of the pivot pin 50. A restriction shaft section 502 is formed at one end of the pivot pin 50. The restriction shaft section 502 has a plane face 503. The restriction shaft section 502 extends through the pinhole 52 of the sideboard 51 with the flange section 501 abutting against the sideboard 51. A stop block 56 is disposed between the flange section 501 and the sideboard 51. The stop block 56 is synchronously rotatable with the pivot pin 50. Two opposite stop sections 561, 562 are formed on a circumference of the stop block 56. The stop section 55 of the sideboard 51 can stop the stop sections 561, 562 to restrict the rotational angle. The first and second cams 6, 6a is rotatably fitted on the restriction shaft section 502. The first cam 6 has two fixing keys 61 fixedly inserted in two corresponding fixing sections 53, 54 of the sideboard 51, (such as two fixing holes 54 or two fixing notches 53 or a fixing notch 53 and a fixing hole 54). The second cam 6a has two fixing keys 61a fixedly inserted in two corresponding fixing sections of the retainer plate 7, (such as two fixing notches 71). The opposite sides of the first and second cams 6, 6a respectively have frictional faces. The frictional faces are respectively formed with raised sections 64, 64a and recessed sections 63, 63a. The retainer plates 7, 7a are synchronously drivingly fitted on the restriction shaft section 502. The elastic member 70 is positioned between the retainer plates 7, 7a. The elastic member 70 is composed of multiple arcuate leaf springs 701, which are synchronously drivingly fitted on the restriction shaft section 502. In addition, a fastening member 504 is affixed to the end of the restriction shaft section 502 for fastening the retainer plate 7a.

In practice, when the first and second cams 6, 6a are positioned in a home position, the raised section 64 of the first cam 6 is inlaid in the recessed section 63a of the second cam 6a, while the raised section 64a of the second cam 6a is correspondingly inlaid in the recessed section 63 of the first cam 6 to provide a locating effect.

When the pivot pin 50 is rotated relative to the pivot seat 5, the restriction shaft section 502 drives the retainer plate 7 to rotate. At this time, the second cam 6a is synchronously rotated with the pivot pin 50. Under such circumstance, the raised section 64 of the first cam 6 is moved out of the recessed section 63a of the second cam 6a into contact with the frictional face of the second cam 6a, while the raised section 64a of the second cam 6a is moved out of the recessed section 63 of the first cam 6 into contact with the frictional face of the first cam 6 to change the torsion. When the pivot pin 50 is restored to its home position, the raised sections 64, 64a gradually approach the recessed sections 63a, 63 to be automatically inlaid back into the recessed sections 63a, 63 again.

In such structure, the pivot pin 50 can be freely located at a specific angle under sufficient frictional force. However, the arcuate leaf springs 701 can only provide limited elasticity so that it is hard to provide greater frictional force for the pivot pin 50. Therefore, such structure can be hardly applied to a large-size electronic product for locating the snap-on cover. Moreover, such structure is relatively complicated and is difficult to assemble. Also, it is uneasy to replace the elastic member 70. Furthermore, the frictional force applied to the pivot pin 50 is fixed and unadjustable.

### SUMMARY OF THE INVENTION

It is therefore a primary object of the present invention to provide an improved elastic hold-type rotary shaft structure. In the rotary shaft structure, the elastic member connected between two holding members can be easily replaced with a larger one with greater or different elastic coefficient. Therefore, the holding members can apply a greater or different elastic holding force to the rotary shaft in accordance with different requirements. Accordingly, the frictional resistance against the rotary shaft is easily adjustable to facilitate application.

It is a further object of the present invention to provide the above elastic hold-type rotary shaft structure, an elastic member with greater elastic coefficient can act on the rotary shaft via the two holding members to provide greater frictional resistance against the rotary shaft. In this case, the rotary shaft is applicable to large-size electronic product to widen the application range.

It is still a further object of the present invention to provide the above elastic hold-type rotary shaft structure, which has very simple structure and is easy to assemble. Therefore, the manufacturing cost for the rotary shaft structure is lowered to promote competitive power of the product.

To achieve the above and other objects, the elastic hold-type rotary shaft structure of the present invention includes: a first holding member and a second holding member, one side of the first holding member being formed with a pivot section and one side of the second holding member being formed with another pivot section, the pivot sections of the first and second holding members being pivotally connected with each other, the first and second holding members being formed with corresponding holding sections for receiving a rotary shaft; and at least one elastic member connected between the other sides of the first and second holding members distal from the pivot sections, whereby the elastic member provides an elastic force to keep the first and second holding members elastically holding the rotary shaft and applying a frictional force to the rotary shaft.

In the above elastic hold-type rotary shaft structure, the other sides of the first and second holding members are respectively formed with two connection sections distal from the pivot sections, the elastic member being connected between the connection sections.

In the above elastic hold-type rotary shaft structure, the elastic member is a spring.

In the above elastic hold-type rotary shaft structure, two end sections of the spring are respectively formed with two assembling sections for connecting with the connection sections.

In the above elastic hold-type rotary shaft structure, the connection sections are raised sections protruding from the other sides of the first and second holding members and the assembling sections are hook sections.

In the above elastic hold-type rotary shaft structure, a top of each of the raised sections is formed with an enlarged stop section.

In the above elastic hold-type rotary shaft structure, the elastic member includes a connection member passing through the other sides of the first and second holding members distal from the pivot sections, one end of the connection member being formed with a stop section in abutment with outer side of one of the holding members, a movable stop member being disposed at the other end of the connection member, a resilient member being compressed between the movable stop member and outer side of the other of the holding members.

In the above elastic hold-type rotary shaft structure, the elastic member includes a connection member passing through the connection sections of the first and second holding members, one end of the connection member being formed with a stop section in abutment with outer side of one of the connection sections, a movable stop member being disposed at the other end of the connection member, a resilient member being compressed between the movable stop member and outer side of the other of the connection sections.

In the above elastic hold-type rotary shaft structure, the connection member is a bolt, the movable stop member is a nut and the resilient member is a spring.

In the above elastic hold-type rotary shaft structure, the rotary shaft has a circular cross section.

In the above elastic hold-type rotary shaft structure, the rotary shaft has a noncircular cross section.

The present invention can be best understood through the following description and accompanying drawings, wherein:

### BRIEF DESCRIPTION OF THE DRAWINGS

FIG. 1 is a perspective exploded view of a conventional rotary shaft structure with elastic holding effect;

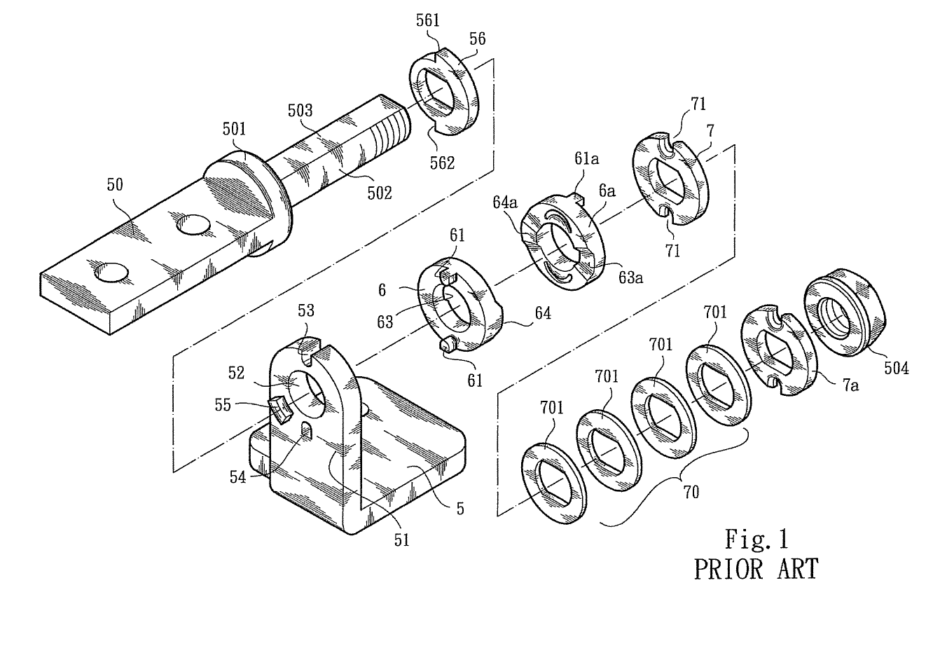

FIG. 2 is a perspective assembled view of the conventional rotary shaft structure according to FIG. 1;

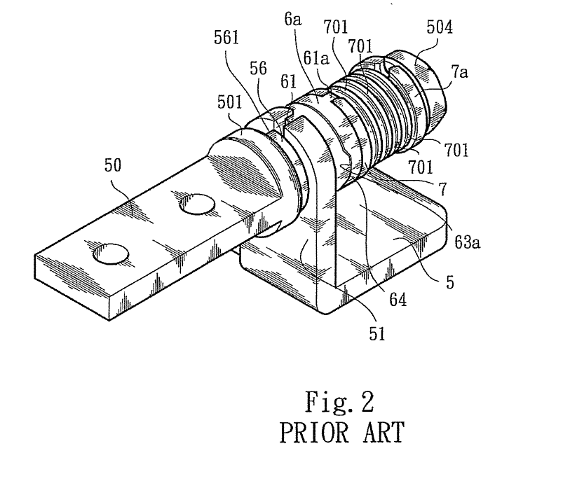

FIG. 3 is a perspective exploded view of a first embodiment of the elastic hold-type rotary shaft structure of the present invention;

FIG. 4 is a perspective assembled view of the first embodiment of the elastic hold-type rotary shaft structure of the present invention;

FIG. 5 is a sectional assembled view of the first embodiment of the elastic hold-type rotary shaft structure of the present invention;

FIG. 6 is a perspective assembled view of a second embodiment of the elastic hold-type rotary shaft structure of the present invention; and

FIG. 7 is a sectional assembled view of the second embodiment of the elastic hold-type rotary shaft structure of the present invention.

### DETAILED DESCRIPTION OF THE PREFERRED EMBODIMENTS

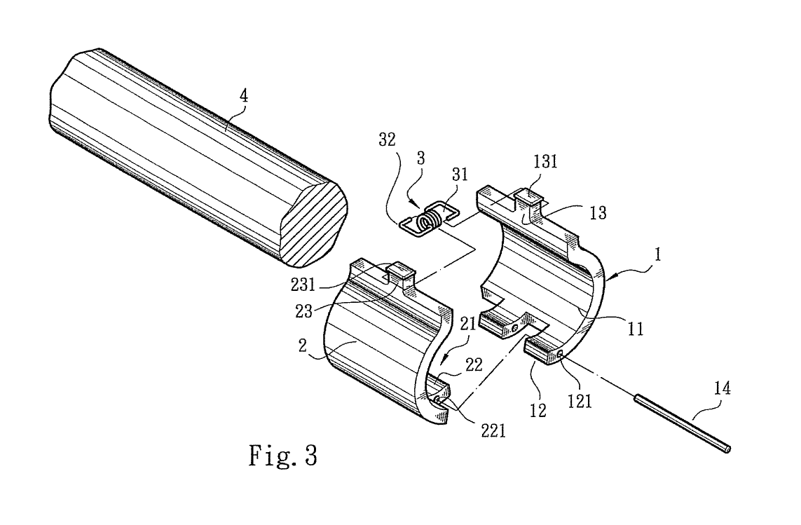

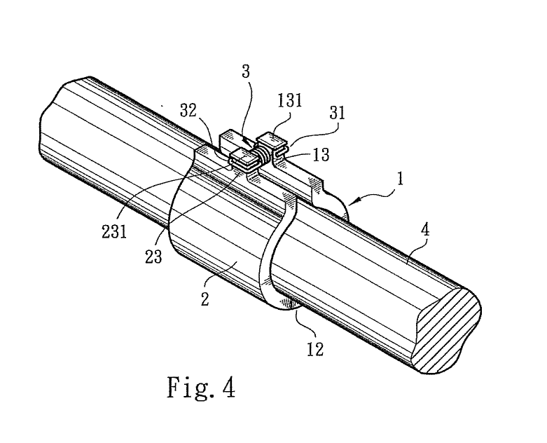

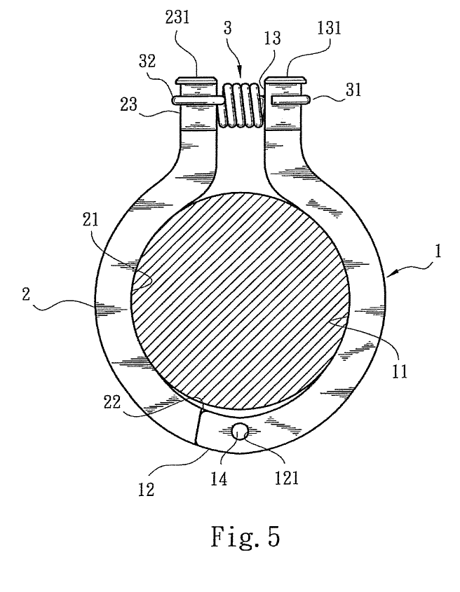

Please refer to FIGS. 3 to 5. According to a first embodiment, the elastic hold-type rotary shaft structure of the present invention mainly includes a first holding member 1, a second holding member 2 and an elastic member 3. One side of the first holding member 1 is formed with a pivot section 12 and one side of the second holding member 2 is also formed with a pivot section 22. Each of the pivot sections 12, 22 is formed with a pinhole 121, 221. A pin member 14 is passed through the pinholes 121, 221 to pivotally connect the first and second holding members 1, 2 about the pivot sections 12, 22. The middle section of each of the holding members 1, 2 is formed with a concave holding section 11, 21 for receiving a rotary shaft 4. In addition, the other sides of the first and second holding members 1, 2 are formed with connection sections 13, 23 distal from the pivot sections 12, 22. In this embodiment, the connection sections 13, 23 are raised sections protruding from the other sides. The elastic member 3 can be a spring. Two end sections of the spring 3 are formed with two assembling sections 31, 32 respectively. In this embodiment, the assembling sections 31, 32 are hook sections connectable with the connection sections 13, 23 (raised sections). The top of each of the connection sections 13, 23 is formed with an enlarged stop section 131, 231 for preventing the assembling sections 31, 32 from slipping away from the connection sections 13, 23.

In operation, the elastic member 3 (spring) provides an elastic force to keep the first and second holding members 1, 2 elastically holding the rotary shaft 4. When the rotary shaft 4 is rotated, the first and second holding members 1, 2 apply a proper frictional force to the rotary shaft 4, whereby the rotary shaft 4 can be located in any desired angular position. In the above structure, the elastic member 3 can be very easily replaced with a larger one with greater or different elastic coefficient. Therefore, the first and second holding members 1, 2 can apply a greater or different elastic holding force to the rotary shaft 4 in accordance with different requirements.

In the above embodiment, the rotary shaft 4 has a circular cross section. However, in practice, the rotary shaft 4 can have noncircular cross section (such as elliptic, right polygonal or asymmetrically polygonal cross section). In this case, when rotated, the rotary shaft 4 can be more reliably located in a desired angular position.

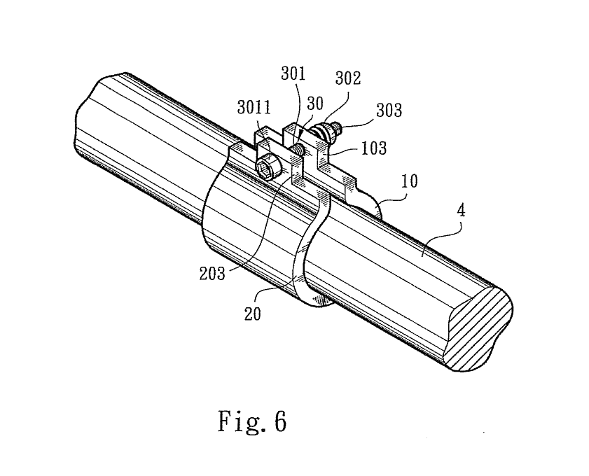

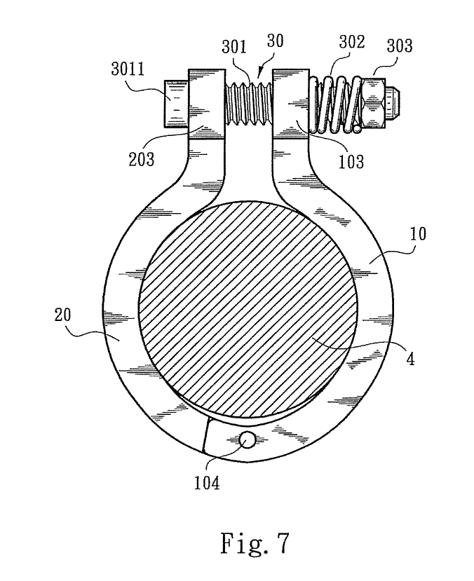

FIGS. 6 and 7 show a second embodiment of the present invention. According to the second embodiment, the elastic hold-type rotary shaft structure of the present invention includes a first holding member 10, a second holding member 20 and an elastic member 30. One side of the first holding member 10 is pivotally connected with one side of the second holding member 20 via a pin member 104. The middle sections of the first and second holding members 10, 20 serve to hold a rotary shaft 4. The other sides of the first and second holding members 10, 20 are formed with connection sections 103, 203. The elastic member 30 includes a connection member 301, (which can be a bolt). The connection member 301 can pass through the connection sections 103, 203. One end of the connection member 301 is formed with a stop section 3011 in abutment with outer side of one of the connection sections 103, 203. A movable stop member 303, (which can be a nut screwed on the bolt), is disposed at the other end of the connection member 301. A resilient member 302 such as a spring is compressed between the movable stop member 303 and outer side of the other of the connection sections 103, 203.

In practice, the stop section 3011 of one end of the connection member 301 and the resilient member 302 (spring) act on the two connection sections 103, 203, whereby the first and second holding members 10, 20 elastically hold the rotary shaft 4. This can achieve the same effect as the first embodiment.

In conclusion, the elastic hold-type rotary shaft structure of the present invention is easily adjustable in elasticity to provide greater holding force.

The above embodiments are only used to illustrate the present invention, not intended to limit the scope thereof. Many modifications of the above embodiments can be made without departing from the spirit of the present invention.

What is claimed is:

1. An elastic hold-type rotary shaft structure comprising:
a first holding member and a second holding member, one side of the first holding member being formed with a pivot section and one side of the second holding member being formed with another pivot section, the pivot sections of the first and second holding members being pivotally connected with each other, the first and second holding members being formed with corresponding holding sections for receiving a rotary shaft; and
at least one elastic member connected between the other sides of the first and second holding members distal from the pivot sections, whereby the elastic member provides an elastic force to keep the first and second holding members elastically holding the rotary shaft and applying a frictional force to the rotary shaft.

2. The elastic hold-type rotary shaft structure as claimed in claim 1, wherein the other sides of the first and second holding members are respectively formed with two connection sections distal from the pivot sections, the elastic member being connected between the connection sections.

3. The elastic hold-type rotary shaft structure as claimed in claim 1, wherein the elastic member is a spring.

4. The elastic hold-type rotary shaft structure as claimed in claim 2, wherein the elastic member is a spring.

5. The elastic hold-type rotary shaft structure as claimed in claim 4, wherein two end sections of the spring are respectively formed with two assembling sections for connecting with the connection sections.

6. The elastic hold-type rotary shaft structure as claimed in claim 5, wherein the connection sections are raised sections protruding from the other sides of the first and second holding members and the assembling sections are hook sections.

7. The elastic hold-type rotary shaft structure as claimed in claim 6, wherein a top of each of the raised sections is formed with an enlarged stop section.

8. The elastic hold-type rotary shaft structure as claimed in claim 1, wherein the elastic member includes a connection member passing through the other sides of the first and second holding members distal from the pivot sections, one end of the connection member being formed with a stop section in abutment with outer side of one of the holding members, a movable stop member being disposed at the other end of the connection member, a resilient member being compressed between the movable stop member and outer side of the other of the holding members.

9. The elastic hold-type rotary shaft structure as claimed in claim 2, wherein the elastic member includes a connection member passing through the connection sections of the first and second holding members, one end of the connection member being formed with a stop section in abutment with outer side of one of the connection sections, a movable stop member being disposed at the other end of the connection member, a resilient member being compressed between the movable stop member and outer side of the other of the connection sections.

10. The elastic hold-type rotary shaft structure as claimed in claim 8, wherein the connection member is a bolt, the movable stop member is a nut and the resilient member is a spring.

11. The elastic hold-type rotary shaft structure as claimed in claim 9, wherein the connection member is a bolt, the movable stop member is a nut and the resilient member is a spring.

12. The elastic hold-type rotary shaft structure as claimed in claim 1, wherein the rotary shaft has a circular cross section.

13. The elastic hold-type rotary shaft structure as claimed in claim 2, wherein the rotary shaft has a circular cross section.

14. The elastic hold-type rotary shaft structure as claimed in claim 5, wherein the rotary shaft has a circular cross section.

15. The elastic hold-type rotary shaft structure as claimed in claim 8, wherein the rotary shaft has a circular cross section.

16. The elastic hold-type rotary shaft structure as claimed in claim 9, wherein the rotary shaft has a circular cross section.

17. The elastic hold-type rotary shaft structure as claimed in claim 10, wherein the rotary shaft has a circular cross section.

18. The elastic hold-type rotary shaft structure as claimed in claim 1, wherein the rotary shaft has a noncircular cross section.

19. The elastic hold-type rotary shaft structure as claimed in claim 2, wherein the rotary shaft has a noncircular cross section.

20. The elastic hold-type rotary shaft structure as claimed in claim 5, wherein the rotary shaft has a noncircular cross section.

21. The elastic hold-type rotary shaft structure as claimed in claim 8, wherein the rotary shaft has a noncircular cross section.

22. The elastic hold-type rotary shaft structure as claimed in claim 9, wherein the rotary shaft has a noncircular cross section.

23. The elastic hold-type rotary shaft structure as claimed in claim 10, wherein the rotary shaft has a noncircular cross section.
